(19) United States
(12) Patent Application Publication
(10) Pub. No.: US 2023/0106100 A1
(43) Pub. Date: Apr. 6, 2023

(54) SPHERICAL TOKAMAK WITH HIGH POWER GAIN RATIO

(71) Applicant: Tokamak Energy Ltd, Abingdon Oxfordshire (GB)

(72) Inventors: Alan Costley, Abingdon Oxfordshire (GB); David Kingham, Abingdon Oxfordshire (GB)

(21) Appl. No.: 17/906,141

(22) PCT Filed: Mar. 17, 2021
(86) PCT No.: PCT/EP2021/056868

§ 371 Date: Sep. 12, 2022

(30) Foreign Application Priority Data
Mar. 27, 2020 (GB) 2004463.2

(51) Int. Cl. G21B 1/05

(52) U.S. Cl. CPC G21B 1/057

(57) ABSTRACT

A tokamak fusion reactor. The tokamak fusion reactor comprises a toroidal plasma chamber and a plasma confinement system arranged to generate a magnetic field for confining a plasma in the plasma chamber. The plasma confinement system comprises toroidal field magnets, which generate a magnetic field, B_{T0}, in the centre of the plasma. The toroidal field magnets are configured such that, in use, the magnetic field, on conductor of the toroidal field magnets is at least 20 Tesla. The plasma confinement system is configured such that, in use, the plasma has: an aspect ratio, A, of 2 or less; an elongation, K, of at least 2; a major radius R₀ of 3.5 meters or less; a normalised beta of at least 3; an engineering safety factor, q_{eng}, of at least 2.0; wherein the engineering safety factor q_{eng} is defined as: g_{eng}=5 B_{T0}R₀K/A²I_{P} where Iₚ is the plasma current; a ratio of the fusion gain, Q_{fus} to the fusion power, P_{fus}, greater than 0.03 MW⁻¹ at fusion power, P_{fus}, less than 500 MW.

### FIELD OF THE INVENTION

This invention relates to spherical tokamak fusion reactors, e.g. for use to produce net power with high gain, as an experimental device, or as a neutron source or for scientific purposes.

### BACKGROUND

The challenge of producing fusion power is hugely complex. Many alternative devices apart from tokamaks have been proposed, though none have yet produced any results comparable with the best tokamaks currently operating such as JET.

World fusion research entered a new phase after the beginning of the construction of ITER, the largest and most expensive (c20bn Euros) tokamak ever built, and various other projects in both the private and public sectors. The successful route to a commercial fusion reactor demands long pulse, stable operation combined with the high efficiency required to make electricity production economic.

For a steady state tokamak plasma with current and energy balance under optimum conditions, the following relationships are true (symbols are defined under the heading “definitions and symbols”)

V∝R₀a²κ∝R₀³κ/A²P_{fus}∝n²T²R₀³κ/A² P_{L}∝nTR₀³κ/A²(τ_{E})_{stored energy}

Greenwald density n∝IₚA²/R₀²β∝nT/B_{T0}²∝β_{N}I_{P}A/R₀B_{T0} q_{eng}=5B_{T0}R₀κ/A²I_{P}

For large aspect ratio tokamaks, experimental confinement times are typically of the form:

(τ_{E})_{scaling}∝IₚR₀^{3/2}a^{1/2}n^{1/2}κ^{3/4}/P_{L}^{1/2}∝IₚR₀²n^{1/2}κ^{3/4}/A^{1/2}P_{L}^{1/2}

(τ_{E})_{stored energy}=τ_{E}=H(τ_{E})_{scaling} where H is a simple multiplier (the subscript “stored energy” refers to actual measured or calculated values of a tokamak plasma. The subscript “scaling” refers to an expression calculated through analysis of the measured performance of multiple tokamak plasmas, to allow the dependency of the confinement time on the engineering parameters such as toroidal magnetic field and plasma size to be determined and so

τ_{E}∝H(IₚR₀²n^{1/2}κ^{3/4}/A^{1/2})(Aτ_{E}^{1/2}/n^{1/2}T^{1/2}κ^{1/2}R₀^{3/2})

Hence τ_{E}^{1/2}∝HIₚR₀^{1/2}κ^{1/4}A^{1/2}/T^{1/2}

So nTτ_{E}∝H²Iₚ²R₀nκ^{1/2}A

Assuming operation at a fixed fraction of the density limit, we can eliminate n using n∝IₚA²/R₀², and we can eliminate Iₚ using I_{P}∝B_{T0}R₀κ/A²q_{eng} and this gives:

$$nT {τ}_{E} \sim \frac{{H}^{2}}{{q}_{eng}^{3}} {R}_{0}^{2} {B}_{T 0}^{3} ( \frac{{κ}^{7 / 2}}{{A}^{3}} ) \qquad ( 1 )$$

For a fusion reactor using deuterium-tritium fuel to produce self-sustaining levels of alpha particle heating (known as “burning plasma”), the “fusion triple product” (nTτ_{E}) must be greater than a critical value, 3×10²¹ m³keVs⁻¹, and the plasma temperature must be in the range 10-20 keV. Thus this equation shows the three basic approaches to designing tokamak power plants—high size (R₀) such as ITER, high “shape” (κ/A) such as spherical tokamaks, and high field (B_{T0}).

However, it can also be seen that there is a significant inverse dependence on the “safety factor” q_{eng}.

The safety factor, q, is a local quantity. It is related to the pitch-angle of the local magnetic field. Formally, it is the number of times a magnetic field lines circles the torus in a toroidal direction before returning to its position in the poloidal plane. For tokamak equilibrium, q rises monotonically towards the plasma edge. Usually, the value of q for both spherical and conventional tokamaks is ˜1 in the plasma centre. For conventional tokamaks, q at the edge is typically ˜2 or 3. For spherical tokamaks, for the same B_{T0} and plasma current, Iₚ, q at the edge is much higher, typically 5 or more and can be >10. A higher q gives a higher plasma stability—less liable to disrupt—and so this is an advantage of the spherical tokamak. A useful parameter to characterise this benefit is q₉₅. q₉₅ is the safety factor on the magnetic surface covering 95% of the toroidal magnetic flux of the plasma column, i.e. near the edge. It can be estimated from:

$${q}_{95} = \frac{5 {aB}_{T 0}}{2 {AI}_{p}} \frac{[ 1 + {κ}^{2} ( 1 + 2 {δ}^{2} - 1.2 {δ}^{3} ) ] ( 1.17 - 0.65 {A}^{- 1} )}{{( 1 - {A}^{- 2} )}^{2}}$$

It is because spherical tokamaks have a relatively high κ and relatively low A, that q₉₅ is higher for a given a, B_{T0} and I_{P}. Alternatively, one can use this advantage by operating at the same value of q₉₅, and hence comparable stability, but much higher plasma current for the same values of a, B_{T0}. In this case the gain in plasma current is also ˜2 to 3 times, compared to an equivalent conventional tokamak.

Experiments have shown that to avoid disruption within a tokamak, q_{eng} should be greater than 2.0, and preferably greater than 3—which represents a significant reduction of nTτ_{E}.

To obtain the fusion reactions required for economic power generation (i.e. much more power out than power in), the conventional tokamak has to be huge (as exemplified by ITER) to achieve the required value of nTτ_{E}.

### SUMMARY

According to a first aspect, there is provided a tokamak fusion reactor. The tokamak fusion reactor comprises a toroidal plasma chamber and a plasma confinement system arranged to generate a magnetic field for confining a plasma in the plasma chamber. The plasma confinement system comprises toroidal field magnets, which generate a magnetic field, B_{T0}, in the centre of the plasma. The toroidal field magnets are configured such that, in use, the magnetic field, on conductor of the toroidal field magnets is at least 20 Tesla. The plasma confinement system is configured such that, in use, the plasma has:
an aspect ratio, A, of 2 or less;
an elongation, κ, of at least 2;
a major radius R₀ of 3.5 meters or less;
a normalised beta of at least 3;
an engineering safety factor, q_{eng}, of at least 2.0;
wherein the engineering safety factor q_{eng} is defined as:

q_{eng}=5B_{T0}R₀κ/A²I_{P} where Iₚ is the plasma current;
a ratio of the fusion gain, Q_{fus} to the fusion power, P_{fus}, greater than 0.03 MW⁻¹ at fusion power, P_{fus}, less than 500 MW

According to a second aspect of the present invention, there is provided a method of operating a tokamak fusion reactor according to the first aspect, the method comprising:
operating the toroidal field magnets such that the magnetic field, on conductor of the toroidal field magnets is at least 20 Tesla;
operating the plasma confinement system such that the plasma has:
   an aspect ratio, A, of 2 or less;
   an elongation, κ, of at least 2;
   a major radius R₀ of 3.5 meters or less;
   a normalised beta of at least 3;
   an engineering safety factor, q_{eng}, of at least 2.0;
   wherein the engineering safety factor q_{eng} is defined as:

q_{eng}=5B_{T0}R₀κ/A²I_{P} where Iₚ is the plasma current;
a ratio of the fusion gain, Q_{fus} to the fusion power, P_{fus}, greater than 0.03 MW⁻¹ at fusion power, P_{fus}, less than 500 MW.

Further aspects and embodiments are defined in claim 2 et seq.

### Definitions and Symbols

n plasma density

T plasma temperature

τ_{E} energy confinement time

nTτ_{E} “Fusion triple product”

H a simple multiplier (which relates the precise value of τ_{E}, and the scaling value derived from experiments on many plasmas created on many different tokamaks)

q safety factor

q_{eng} “engineering” safety factor q_{eng}=5B_{T0}R₀κ/A²I_{P}

q₉₅ safety factor on the magnetic surface covering 95% of magnetic flux of the plasma column

V plasma volume

a plasma minor radius

R plasma major radius

R₀ radius at plasma centre

B_{T0} toroidal magnetic field at plasma centre

κ elongation at the separatrix, i.e. the ratio of the vertical extent of the plasma separatrix to the horizontal extent

δ plasma triangularity

A aspect ratio

Iₚ Plasma current

P_{fus} fusion power, i.e the rate of energy generation by the fusion of deuterium and tritium nuclei integrated over the plasma volume

Q_{fus} fusion power gain Q_{fus}=P_{fus}/Pₐᵤₓ where Pₐᵤₓ is the power supplied to the plasma by external sources

β “beta”—the ratio of plasma pressure to magnetic pressure, expressed as a percentage

β_{N} “normalised beta”—

$${β}_{N} = β \frac{{B}_{T 0} {R}_{0}}{{I}_{P} A}$$

### BRIEF DESCRIPTION OF THE DRAWINGS

FIG. 1 shows the result of modelling for a conventional tokamak;

FIG. 2 shows the result of equivalent modelling for an exemplary device;

FIG. 3 compares Q_{fus} and P_{fus} in simulations of an exemplary tokamak, and of tokamaks equivalent to ARC and ITER;

FIG. 4 is a cross section of an exemplary spherical tokamak.

### DETAILED DESCRIPTION

It has been found that for a tokamak with:
Toroidal field magnets with a field on the conductor of greater than 20 T
An aspect ratio less than 2
Elongation greater than 2
A major radius less than 3.5 m
A normalised beta of 3 or greater
A safety factor of 2.0 or greater

Using the experimental confinement time scaling derived for a spherical tokamak, the dependence of the fusion triple product on the safety factor is greatly reduced—to around 1/q_{eng} rather than 1/q_{eng}³. The approximate relation found is:

$$nT {τ}_{E} \sim \frac{{H}^{2}}{{q}_{eng}} {R}_{0}^{2} {B}_{T 0}^{3} ( \frac{{κ}^{1 / 2}}{{A}^{1 / 3}} ) \qquad ( 2 )$$

though the difference in the dependence of κ and A cannot be determined completely because the analysis is based on a single device (and goes in the direction to give higher values of nTτ_{E} for the spherical tokamak though this is unlikely to be as significant a factor as the change in dependence of q_{eng}).

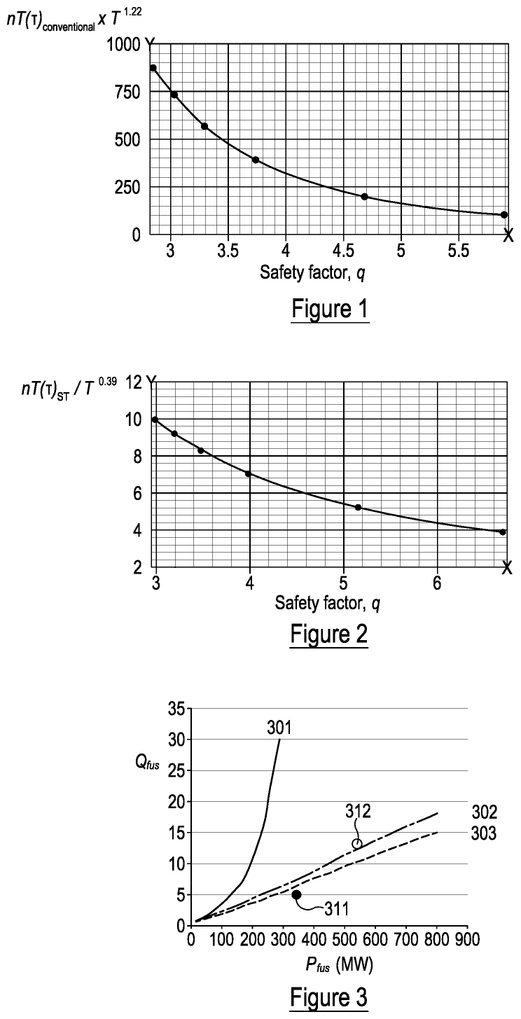

FIGS. 1 and 2 show the result of more detailed modelling for a specified (spherical) tokamak device. The experimental confinement time scaling for a conventional tokamak is used in FIG. 1, whereas the experimental confinement time scaling for a spherical tokamak is used in FIG. 2. In both cases, the simulation was performed by fixing H, R₀, B_{T0}, κ, and A to appropriate values, specifying a required Q_{fus} (fusion gain), and adjusting T and P_{fus} (fusion power) to obtain parameters corresponding to a specific density limit. In the case of the conventional tokamak scaling in FIG. 1, a simple fit to a q_{eng}^{x} power law gives a dependence of q_{eng}⁻³, as expected, but for the spherical tokamak scaling for the device with the properties listed earlier, a similar fit gives a dependence of q_{eng}^{-1.17}.

This approximately q_{eng}² difference carries through to other properties of the reactor—e.g. both Q_{fus} and the fusion triple product will be approximately q_{eng}² times higher for a given P_{fus} on the spherical tokamak described above as for a conventional tokamak. In particular, this enables construction of a reactor with a ratio of Q_{fus} to P_{fus} of at least 0.03 for values of P_{fus} up to 500 MW. At higher P_{fus}, the ratio Q_{fus}/P_{fus} will be higher. For examples, Q_{fus}/P_{fus} greater than 0.04 MW⁻¹ at P_{fus}<700 MW, greater than 0.05 MW⁻¹ at P_{fus}<1000 MW, greater than 0.06 MW⁻¹ at Pfus<1500 MW, greater than 0.07 MW⁻¹ at P_{fus}<2500 MW, or greater than 0.1 MW⁻¹ at P_{fus}<5000 MW. This is a significant improvement over conventional reactors, as, in general, the potential damage to reactor components will scale with P_{fus} (e.g. the power incident on the divertor), but Q_{fus} is a measure of the output power of the reactor. Therefore, a reactor with a higher Q_{fus} for a given P_{fus} will be more efficient as a neutron source, or closer to net power gain for an experimental reactor, or more efficient as a reactor for net power production.

FIG. 3 compares Q_{fus} and P_{fus} in simulations of an exemplary spherical tokamak of 1.5 m major radius (301), an exemplary large tokamak of 6.36 m major radius, similar to ITER (302), and an exemplary small, high field non-spherical tokamak similar to ARC (303). ITER and ARC are marked by circles 311 and 312. As can be seen, the scaling of the ITER-like and ARC-like devices is substantially similar, whereas Q_{fus} for the spherical tokamak device is generally an order of magnitude higher than either of the other devices. In these simulations, the parameters changed were the density, temperature, current, and field, to maintain operation at a fixed normalised beta, and a fixed fraction of the density limit. This means that the safety factor varies slightly (between 2 and 3) across the simulations.

Further simulations and analysis suggests that the q_{eng} dependency of the fusion triple product for spherical tokamaks with the above-listed properties will vary between q_{eng}^{-0.8} and q_{eng}^{-1.5}, compared to between q_{eng}^{-2.5} to q_{eng}^{-3.5} for conventional tokamaks

Turning again for the requirements for the improved safety factor scaling to occur:
Toroidal field magnets with a field on the conductor of greater than 20 T
An aspect ratio less than 2
Elongation greater than 2
A major radius less than 3.5 m
A normalised beta of 3 or greater
A safety factor q_{eng} of 2.0 or greater

The high magnetic field can only be achieved by the use of high temperature superconducting, HTS, magnets. Conventional low temperature superconductors cannot achieve this high a field. Resistive conductors, even if cryogenically cooled, would require so much input power as to render the whole device unfeasible. The aspect ratio, elongation, beta, and safety factor of the plasma result from the configuration of the magnetic field from both the toroidal and poloidal field coils—the required parameters can be determined by calculation and/or simulation as known in the art.

Due to the lower fusion power required for a given fusion triple product or fusion power gain, the design of energy absorbing components of the reactor such as the divertor and first wall will be less restricted than for an equivalent conventional reactor. As such, conventional divertor designs will be sufficient, despite the relatively small size.

Example design aspects of the reactor will be discussed below—but it should be appreciated that the properties listed above are those which are important to the scaling described, however they are achieved. The design principles below are relevant to any spherical tokamak, and similarly other equivalent components may be used (e.g. alternative designs for the divertor, shielding, or magnets) provided they achieve the properties listed earlier.

### High Temperature Superconductors

The combination of higher maximum field, increased current-carrying capability and reduced complexity of cooling means that very high toroidal field HTS magnets are feasible in the limited space of a Spherical Tokamak core. Fusion power is approximately proportional to the cube of the magnetic field, so more powerful magnets will result in a more efficient reactor. An additional benefit is that at these high fields, the charged alpha particles produced during the fusion reaction will remain in the plasma, providing significant self-heating and further increasing the efficiency of the reactor.

High Temperature Superconducting technology continues to advance rapidly. The first generation HTS material, BSCCO, was rapidly overtaken by YBCO. As well as the discovery of new HTS materials with fundamentally higher critical fields and critical currents, the engineering performance of existing materials such as YBCO (or, more generally (Re)BCO where Re is a rare earth atom) is rapidly being improved with the result that magnets made from HTS can achieve increasingly high fields from increasingly small conductors. In the present specification, it will be understood that HTS materials include any material which has superconducting properties at temperatures above about 30 K in a low magnetic field.

The use of high temperature superconductor materials allows for a much higher engineering current density within the central column of the TF magnets. Engineering current densities of greater than 200 A/mm² are readily achievable, and this has been pushed to greater than 1000 A/mm², or even higher.

### Neutron Shielding

HTS requires neutron shielding to avoid damage from neutrons produced by the reactor, as otherwise neutron damage to the tape will eventually cause it to degrade to the point where it can no longer remain superconducting while carrying the required current. One example of a suitable and compact shielding material is tungsten carbide, as described in WO 2016/009176 A1.

### Start-Up and Ramp-Up

In existing tokamaks the plasma current is initiated by transformer action using a large central solenoid, and this may also be used here.

An alternative would be the use of a gyrotron. Experiments on MAST have demonstrated start-up using a 28 GHz 100 kW gyrotron (assisted by vertical field ramp) at an efficiency of 0.7 A/Watt. A gyrotron fitted to a spherical tokamak with the required properties could have power ˜1 MW and is predicted to produce a start-up current of ˜700 kA.

An alternative scheme is to use a small solenoid (or pair of upper/lower solenoids) made using mineral insulation with a small shielding (or designed to be retracted before D-T operation begins); it is expected that such a coil would have approximately 25% of the volt-secs output as an equivalent solenoid as used on MAST or NSTX. Initial currents of order 0.5 MA are expected. The combination of both schemes would be especially efficient.

A novel development of the ‘retractable solenoid’ concept is to use a solenoid wound from HTS, to cool it in a cylinder of liquid nitrogen outside the tokamak, insert it into the centre tube whilst still superconducting, pass the current to produce the initial plasma, then retract the solenoid before D-T operation. Advantages of using HTS include lower power supply requirements, and the high stresses that can be tolerated by the supported HTS winding.

This initial plasma current will be an adequate target for external heating and current drive methods, and the heating and current drive they produce will provide current ramp up to the working level.

### Heating and Current Drive

It is desirable to obtain a significant fluence of neutrons at minimum auxiliary heating and minimum current drive, in order to minimise build costs, running costs, and to keep divertor heat loads at tolerable levels.

Various methods of heating (and current drive) including NBI and a range of radio-frequency (RF) methods may be appropriate.

A potentially helpful feature is the self-driven ‘bootstrap’ current, produced in a hot, high energy, plasma, which can account for one-half or more of the required current. However bootstrap current increases with density, whereas NBI current drive reduces at high density, so a careful optimisation is required.

### Thermal Load on Divertors

Some of the energy pumped into a plasma either to heat it or produce current drive emerges along the scrape-off-layer (SOL) at the edge of the plasma, which is directed by divertor coils to localised divertor strike points. The power per unit area here is of critical concern in all fusion devices, and would not normally be acceptable in a small reactor. However, due to the improved scaling with safety factor, in the present proposal the input power is greatly reduced so the divertor load is correspondingly reduced. Additional methods may be used to reduce the load per unit area further, by a combination of strike-point sweeping; use of the ‘natural divertor’ feature observed on START; and use of divertor coils to direct the exhaust plume. Further benefit may be gained by use of a flow of liquid lithium over the target area which will also be used to pump gases from the vessel, for example in a closed lithium flow loop.

General Outline of this Device

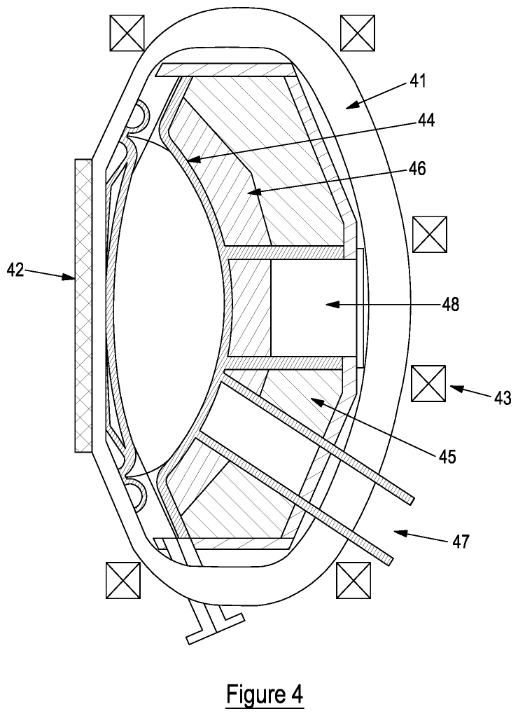

A cross section of a spherical tokamak similar to that described above is shown in FIG. 4. The major components of the tokamak are a toroidal field magnet (TF) 41, optional small central solenoid (CS) 42 and poloidal field (PF) coils 43 that magnetically confine, shape and control the plasma inside a toroidal vacuum vessel 44. The TF magnet, and potentially the CS and PF coils, comprise HTS material. The centring force acting on the D-shaped TF coils 41 is reacted by these coils by wedging in the vault formed by their straight sections. The outer parts of the TF coils 41 and external PF coils are optionally protected from neutron flux by a blanket (which may be D₂O) and shielding 45. The central part of TF coils, central solenoid and divertor coils are only protected by shielding.

The vacuum vessel 44 may be double-walled, comprising a honey-comb structure with plasma facing tiles, and directly supported via the lower ports and other structures. Integrated with the vessel are optional neutron reflectors 46 that could provide confinement of fast neutrons which would provide up to 10-fold multiplication of the neutron flux through ports to the outer blanket where neutrons either can be used for irradiation of targets or other fast neutral applications, or thermalised to low energy to provide a powerful source of slow neutrons. The reason for such assembly is to avoid interaction and capture of slow neutrons in the structures of the tokamak. The outer vessel optionally contains D₂O with an option for future replacement by other types of blanket (Pb, salts, etc.) or inclusion of other elements for different tests and studies. The outer shielding will protect the TF and PF coils, and all other outer structures, from the neutron irradiation. The magnet system (TF, PF) is supported by gravity supports, one beneath each TF coil. Ports are provided for neutral beam injection 47 and for access 48.

Inside the outer vessel the internal components (and their cooling systems) also absorb radiated heat and neutrons from the plasma and partially protect the outer structures and magnet coils from excessive neutron radiation in addition to D₂O. The heat deposited in the internal components in the vessel is ejected to the environment by means of a cooling water system. Special arrangements are employed to bake and consequently clean the plasma-facing surfaces inside the vessel by releasing trapped impurities and fuel gas.

The tokamak fueling system is designed to inject the fueling gas or solid pellets of hydrogen, deuterium, and tritium, as well as impurities in gaseous or solid form. During plasma start-up, low-density gaseous fuel is introduced into the vacuum vessel chamber by the gas injection system. The plasma progresses from electron-cyclotron-heating and EBW assisted initiation, possibly in conjunction with flux from small retractable solenoid(s), and/or a ‘merging-compression’ scheme (as used on START and MAST), to an elongated divertor configuration as the plasma current is ramped up. A major advantage of the ST concept is that the plasmas have low inductance, and hence large plasma currents are readily obtained if required—input of flux from the increasing vertical field necessary to restrain the plasma being significant. Addition of a sequence of plasma rings generated by a simple internal large-radius conductor may also be employed to ramp up the current.

After the current flat top is reached, subsequent plasma fueling (gas or pellets) together with additional heating leads to a D-T burn with a fusion power in the MW range. With non-inductive current drive from the heating systems, the burn duration is envisaged to be extended well above 1000 s and the system is designed for steady-state operations. The integrated plasma control is provided by the PF system, and the pumping, fueling (H, D, T, and, if required, He and impurities such as N2, Ne and Ar), and heating systems based on feedback from diagnostic sensors.

The pulse can be terminated by reducing the power of the auxiliary heating and current drive systems, followed by current ramp-down and plasma termination. The heating and current drive systems and the cooling systems are designed for long pulse operation, but the pulse duration may be determined by the development of hot spots on the plasma facing components and the rise of impurities in the plasma.

Even for reactors which do not achieve net energy production, the increased efficiency of a fusion reactor as described above may be useful in applications such as neutron sources, material test facilities (e.g. testing materials for durability when exposed to fusing plasma), and in experimental devices aiming to push towards further understanding of fusion.

1. A tokamak fusion reactor comprising a toroidal plasma chamber and a plasma confinement system arranged to generate a magnetic field for confining a plasma in the plasma chamber, wherein:
the plasma confinement system comprises toroidal field magnets, which generate a magnetic field, B_{T0}, in the centre of the plasma;
the toroidal field magnets are configured such that, in use, the magnetic field, on conductor of the toroidal field magnets is at least 20 Tesla;
the plasma confinement system is configured such that, in use, the plasma has:
an aspect ratio, A, of 2 or less;
an elongation, κ, of at least 2;
a major radius R₀ of 3.5 meters or less;
a normalised beta of at least 3;
an engineering safety factor, q_{eng}, of at least 2.0,
wherein the engineering safety factor q_{eng} is defined as:
q_{eng}=5B_{T0}R₀κ/A²I_{P} where Iₚ is the plasma current; and
a ratio of the fusion gain, Q_{fus}, to the fusion power, P_{fus}, greater than 0.03 MW⁻¹ at fusion power, P_{fus}, less than 500 MW.

2. A tokamak fusion reactor according to claim 1, wherein the toroidal field magnets comprise high temperature superconducting, HTS, ReBCO materials.

3. A tokamak fusion reactor according to claim 2, wherein an engineering current density in the central column of the toroidal field magnet is at least 200 amps per square millimetre, more preferably at least 300 amps per square millimetre, more preferably at least 350 amps per square millimetre.

4. A tokamak fusion reactor according to claim 1, wherein the aspect ratio is 1.9 or less, more preferably 1.8 or less, more preferably 1.7 or less.

5. A tokamak fusion reactor according to claim 1, wherein the elongation is at least 2.4, more preferably at least 2.7, more preferably at least 2.9.

6. A tokamak fusion reactor according to claim 1, wherein the major radius is 3 meters or less, more preferably 2.7 meters or less, more preferably 2.4 meters or less.

7. A tokamak fusion reactor according to claim 1, wherein the normalised beta is at least 5, more preferably at least 10.

8. A tokamak fusion reactor according to claim 1, wherein the engineering safety factor is 5 or greater, more preferably 10 or greater.

9. A tokamak fusion reactor according to claim 1, wherein the ratio of Qfus/Pfus is greater than 0.04 MW−1 at Pfus<700 MW, more preferably greater than 0.05 MW−1 at Pfus<1000 MW, more preferably greater than 0.06 MW−1 at Pfus<1500 MW, more preferably greater than 0.07 MW−1 at Pfus<2500 MW, more preferably greater than 0.1 MW−1 at Pfus<5000 MW.

10. A tokamak fusion reactor according to claim 1, wherein the primary means of plasma current drive is a gyrotron.

11. A tokamak fusion reactor according to claim 1, further comprising a divertor having a surface coated with lithium.

12. A neutron source comprising a tokamak fusion reactor according to claim 1.

13. A method of operating a tokamak fusion reactor, the tokamak fusion reactor comprising a toroidal plasma chamber and a plasma confinement system arranged to generate a magnetic field for confining a plasma in the plasma chamber, wherein the plasma confinement system comprises toroidal field magnets, which generate a magnetic field, B_{T0}, in the centre of the plasma, the method comprising:
operating the toroidal field magnets such that the magnetic field, on conductor of the toroidal field magnets is at least 20 Tesla;
operating the plasma confinement system such that the plasma has:
an aspect ratio, A, of 2 or less;
an elongation, κ, of at least 2;
a major radius R₀ of 3.5 meters or less;
a normalised beta of at least 3;
an engineering safety factor, q_{eng}, of at least 2.0,
wherein the engineering safety factor q_{eng} is defined as:
q_{eng}=5B_{T0}R₀κ/A²I_{P} where Iₚ is the plasma current; and
a ratio of the fusion gain, Q_{fus}, to the fusion power, P_{fus}, greater than 0.03 MW⁻¹ at fusion power, P_{fus}, less than 500 MW.
